(19) United States
(12) Patent Application Publication
(10) Pub. No.: US 2007/0273494 A1
(43) Pub. Date: Nov. 29, 2007

(54) Display Device and Method for Control of a Display Device for Motor Vehicles

(76) Inventors: Wolfgang Dittrich, Auenwald (DE); Sascha Paasche, Tokyo (JP); Wolfgang Stephan, Weinstadt (DE); Jean Terree, Stuttgart (DE); Michael Wolf, Stuttgart (DE)

Correspondence Address: KENYON & KENYON LLP, ONE BROADWAY, NEW YORK, NY, 10004, US

(21) Appl. No.: 10/563,666

(22) PCT Filed: Jul. 2, 2004
(86) PCT No.: PCT/EP04/07182

§ 371 Date: Mar. 30, 2007

(30) Foreign Application Priority Data
Jul. 21, 2003 (DE) 103 30 741.9

(51) Int. Cl. B60Q 1/00

(52) U.S. Cl. 340/461

(57) ABSTRACT

The invention relates to a display device for motor vehicles and a method for control of a display device for motor vehicles, particularly motor vehicles which require an additive in addition to the fuel for operation thereof, which is used up as a function of the fuel used and further driving parameters. By means of the inventive display device, the range of the additive reservoir is displayed with relation to the range of a full fuel tank.

### FIELD OF THE INVENTION

The present invention relates to a display device for motor vehicles and to a method for actuating a display device for motor vehicles.

### BACKGROUND INFORMATION

From October 2005 onward, commercial vehicles, such as trucks and buses, have to comply with the new Euro 4 exhaust gas standards established by the European Union, which defines new limits for nitrogen oxides and particulate emissions. What is referred to as selective catalytic reduction (SCR) is suitable for complying with these limits. In this method for exhaust gas aftertreatment, the pollutants are rendered harmless with the aid of an aqueous urea solution which is injected into a catalytic converter located in the exhaust. The operating substance which is required for the SCR process and has been introduced to the market under the internationally applicable product name AdBlue is carried in a separate tank by the vehicles. However, extensive coverage of refueling stations which sell AdBlue is only likely to take hold gradually.

To use the SCR technology, commercial vehicles are retrofitted or built with an additional tank. Very different ratios in the storage volumes which are present for diesel and AdBlue may result, depending on the type of vehicle and series. Depending on the engine equipment and the manner in which the vehicle is driven, the consumption of AdBlue may fluctuate between 2 and 6 percent by volume of the diesel consumption. Working on the basis of the sensible assumption that the tank volume for the additive AdBlue will at least be selected such that a full AdBlue tank is always sufficient for the range of at least one full diesel tank, very different range ratios of AdBlue to diesel may nevertheless result from the combination of the different diesel tank volumes with different possible AdBlue tank volumes. For example, working on the basis of 6% of AdBlue being consumed based on diesel consumption, the combination of a diesel tank with a capacity of 380 liters and an AdBlue tank with a capacity of 25 liters gives a range ratio of the store of AdBlue to the store of diesel of 1.1. That is, a full AdBlue tank is sufficient for 1.1 diesel tank fillings. However, the same type of vehicle may also be equipped with a diesel tank with a capacity of 125 liters and an AdBlue tank with a capacity of 45 liters, resulting in a range ratio of 6 full tanks of diesel to one full tank of AdBlue. In the case of larger vehicles with a diesel tank volume of from 400 up to 1400 liters combined with AdBlue tank volumes of 90 or 145 liters, range ratios of between 1 and 6 times the range of the store of AdBlue with respect to the store of diesel likewise result. The manner in which the tank ratios are selected is a question of driving routes and the availability of refueling stations which sell AdBlue. In view of the background whereby the AdBlue-to-diesel range ratios vary considerably from vehicle to vehicle, a conventional level indicator of the AdBlue tank contents, corresponding to conventional devices for indicating tank contents, is unsuitable for professional drivers, who normally have to cope with frequent vehicle changes. For example, if the reserve display for the AdBlue tank lights up at a filling level of 14% of the tank volume, this filling level could under suitable conditions still be sufficient for the range of another full tank of diesel. The displaying of the AdBlue filling level has no meaning for the driver if he does not know the ratio of the volumes of diesel tank to AdBlue tank. Even if he does know this ratio, he would still have to establish the ratio of the consumption of diesel and AdBlue in order to be able to understand the importance of the level indicator for AdBlue. This type of consumption relationship between diesel filling level and AdBlue filling level could only be learned by gaining familiarity through prolonged involvement with vehicles with the same tank ratios and consumption relationships. This situation does not usually occur for professional drivers.

A display for estimating the range of the store of AdBlue should therefore be in such a form for a professional driver that it is possible to avoid a separate refueling stop for this additive. And since there may not initially be extensive coverage of refueling stations which sell AdBlue, it may also be important for the driver for the display to enable him to plan refueling stops for taking on AdBlue in advance.

German Published Patent Application No. 39 36 373 describes a device for motor vehicles for optically displaying two values. One of the two values shows a variable which is dependent on the store of fuel and the other value shows a variable which is dependent on the fuel consumption. The two values are compared with one another to form a difference, so that the driver can estimate from the relationship between store of fuel and current fuel consumption indicated the range for the store of fuel. With this display, it is possible to obtain a more accurate estimate for the range of the store of fuel—e.g., as a function of the manner in which the vehicle is driven—than if the remaining store of fuel alone is disclosed. However, this form of display is unsuitable for solving the problem of estimating the range for two combined operating substances. Even if the consumption of the additive in the sense of the present document is applied, as a variable dependent on the consumption of the fuel, as the subtrahend with respect to the store of fuel, this does not give a statement of whether the existing store of additive is sufficient for another full fuel tank.

German Published Patent Application No. 199 59 597 describes a method and a device for optically displaying information in motor vehicles. Two variables which are operatively related are compared, with the comparison being made by successively indicating the variables on one display at the same site. The operative relationships relate to pairs of values such as tank contents/range, range/distance, current consumption/average consumption, total driving time/driving time covered, i.e., the comparison is either based on the same physical unit and then illustrates a difference which is present, or one physical unit, which is less meaningful to the driver—in the case of the pairs of values of tank contents/range being presented—is converted into a different, more meaningful unit. This approach may not solve the problem of meaningfully indicating a relationship between store of fuel/store of additive, since the ratios between store of fuel and store of additive, which differ according to the type of vehicle, do not allow a uniform reference basis for producing the direct relationships between two values which have just been described.

### SUMMARY

Example embodiments of the present invention may provide a display device and a method for motor vehicles which allow topping up an additive which is not available at all refueling stations and is required for operation of the vehicle to be planned such that refueling stops exclusively for topping up the additive may be avoided.

Working on the basis of a range for the store of additive which is displayed by the display device, by electronically actuable display elements which are actuated in accordance with the method for actuating a display device, the driver may establish at a glance whether or not the existing store of additive is sufficient for another full fuel tank, since the range of the store of additive is indicated based on the range of a full fuel tank. Thus, if, as the fuel starts to run low, a range for the additive which is sufficient for a full fuel tank—referred to below as the full range for short—is displayed, the driver is not tied to selecting the next refueling station as one that offers the additive. If, as the store of fuel drops, less than the full range for the additive is displayed at any time, this indicates to the driver that the additive should also be topped up at the next refueling stop, in order to avoid having to make a later refueling stop just for the additive.

The term “range” in the present context should not be understood specifically as kilometer information. For example, for the intended purposes of the display device, as an indication of the range of the store of fuel it is also appropriate to display the contents of the tank, since the driver may usually interpret this information with sufficient accuracy as the range with regard to the next refueling stop which is due. Indications of the store of fuel or kilometer information may be of equal value for estimating the remaining room for maneuver for finding a refueling station, especially since kilometer information is not definitive variables, but rather have to be corrected depending on the manner in which the vehicle is driven and/or the terrain. Therefore, in the following, a display of a range for the store of fuel is also to be understood as including a direct indication of the store of fuel. This correlation of store and range with regard to the estimation of a range, however, applies only to the fuel. For the reasons which have already been presented in the introduction, a simple indication of the store of additive may not be interpreted as a range, and consequently the range of the store of additive is “converted” into a variable which may be interpreted on the basis of the store of fuel (and therefore also the fuel range). This variable expresses how much fuel the current store of additive is sufficient for or what fuel range the additive range is sufficient for.

If the display device, after refueling with a full fuel tank when the full range of the additive was still present, at any point during subsequent driving displays a value for the range of the store of additive which is lower than the full range, this value cannot decrease more quickly than the value for the range of the store of fuel, since the reference variable for displaying the range of the additive is the full fuel tank, and at the time of refueling with fuel the range of the additive was sufficient for a full fuel tank.

Based on the appropriate assumption that the ratios of the store of fuel and the store of additive are configured such that a completely full store of additive is sufficient for more than the consumption of a full fuel tank, if the driver takes account of the displayed values when looking for a refueling station, the situation may not arise whereby the store of additive starts to run out before the store of fuel. Therefore, the described properties of the display device and of the method for actuating the display device may make it possible to avoid refueling stops exclusively because of the need to top up the additive, since, when refueling of the vehicle with fuel is imminent, it may immediately be read off, on the basis of the indicated range relationship of the store of additive to the maximum fuel volume, whether or not it is possible to avoid topping up the additive.

The situation whereby the store of additive is no longer sufficient for the range of the existing store of fuel may only occur with the display device if the additive is not topped up during a refueling stop which follows an indication that the additive range is dropping. Since the decreasing store of additive is displayed as a range based on a full fuel tank and not as an absolute variable indicating the store, the driver may plan the ability to reach a suitable refueling station based on this indication in the same manner as when a fuel tank starts to empty. For example, if a range of the store of additive corresponding to half the fuel tank is displayed, the driver knows that when searching for a refueling station which offers the additive, he should behave as if he had only a half-full fuel tank. Therefore, until the additive is next topped up, he only has to concentrate on the display of the range of the store of additive, which, based on the manner in which it is referenced to the range of a full fuel tank, may be interpreted in the same manner as the display of the store of fuel or the fuel range.

The relationship of the additive range with respect to the fuel range may be calculated by calculating the ratio ART of the absolute range of the store of additive AR and the range of a full fuel tank KTR in accordance with AR/KTR, with the range AR resulting from the quotient of the current store of additive AV and the current consumption of the additive AC, and the range of the full fuel tank KRT resulting from the quotient of the maximum store of fuel KTV and the current fuel consumption KC. The dimensionless ratio value ART indicates for what level of fuel (or for what fuel range) the existing store of additive is still sufficient. Depending on the ratio of the storage tanks for fuel and additive to one another, the value ART may be greater than 1 or a multiple of 1. To indicate the range of the additive, this value may be restricted to 1. This concentrates the driver's attention on the known parameter “store of fuel” or “fuel range.” Indicating additive ranges which are above the range of a full fuel tank may be unnecessarily diverting, since the only important factor for the driver is whether or not it is necessary to top up the additive at the next refueling stop.

A simpler but less accurate relationship between additive range and fuel range may also be established, for example, by calculating a ratio AV/KTV—standardized to a suitable constant for the ratio of the ranges of the maximum store of additive to the maximum store of fuel—so as to be independent of the current consumptions.

The usefulness of the display device may be increased if there is an integrated display element for indicating a reserve range of the store of additive. This may be actuated such that it signals when the reserve range of the additive and the reserve range of the store of fuel are dropping. The reserve range of the fuel is usually defined by reaching or dropping below a certain fuel level and is signaled by a display element on the fuel gauge or other warnings Signaling a reserve range for the store of additive in the manner described means that not only does the range display for the additive behave analogously to a range display for the fuel, but also the reserve display for the additive behaves analogously to the fuel reserve display. Therefore, if the additive starts to run low before the store of fuel, the driver may plan the next refueling stop in the same manner as will be familiar to him based on the fuel display or fuel range display.

The electronically actuable display elements may be realized by pointers and/or LED display elements. If the range of the fuel is displayed as the tank contents, it may be provided for this indication to use a pointer, since this corresponds to a standard form of indication which is therefore easy to understand. It is in this context irrelevant whether an actual pointer undertakes this function or whether a pointer is indicated on a display. Range information may also be provided in the form of kilometer information, and this information may be indicated in analog form, for example, by bar charts, along suitable scales, as digital values, etc. This may be implemented by a display or using LED display elements which may provide a clearer contrast compared to the use of a display.

There may be a first display element for indicating the range of the store of fuel and a second display element for indicating the range of the store of additive based on a full fuel tank, and both display elements may be referred jointly to one scale. The scale may, as may usually be the case, be a divided scale indicating the tank contents. A value of the store of fuel also may and will, as has already been stated a number of times, usually be interpreted as a range, e.g., since typical fuel gauge scales are not based on a liter scale, but rather allow a filling level—full, three-quarters full, half full, a quarter full or empty—to be read off. This dimensionless form allows the tank needle to be interpreted as full range, three-quarter range, half range, quarter range or reserve range. However, scales giving kilometer information are also suitable for indicating the ranges.

The first display element displays the store of fuel and therefore allows the range in this respect to be estimated. Optical referencing of the second display element to the same scale as well may make the ratio of the range of the store of additive to the reference variable “fuel tank volume” or “full range” apparent, and its combination with the display of the current fuel quantity simultaneously makes the ratio of the two ranges to one another immediately apparent.

On account of the two values being indicated along a common scale, the driver has accurate information as to the range of the stores of his operating substances and as to which substance is still sufficient. For example, if the display elements for the ranges of the two operating substances—fuel and additive—are represented by in each case a dedicated pointer such that it is possible to distinguish between them, and if one pointer indicates a higher value than the other, based on the common scale, it is possible to directly read, on the basis of the relationship, which of the operating substances represented by the pointers will last longer.

The first display element may be realized by a pointer, and the second display element may include a plurality of LED display elements which are arranged along the entire scale, and it being possible for a sufficient number of LED display elements to be actuated so as to light up in succession—starting at the origin of the scale—that the LED display elements which are lit up display the range of the store of additive based on a full fuel tank. Since the ranges for the two operating substances are displayed using display elements of different form—a pointer for the fuel, LED display elements for the additive—it is not possible to become confused between the two variables displayed on the same scale, as may occur, for example, with a configuration using two, albeit differently configured, pointers. The use of a pointer as the first display element corresponds to a standard format for the indication of fuel gauges and therefore does not require any special experience. Indicating the additive range by LED display elements which light up along the scale allows the driver to understand both variables displayed as well as their relationship with respect to one another at a glance and without the risk of confusion.

The scale may be arranged in the form of an arc, and the LED display elements arranged along the entire scale may be correspondingly curved in form. A scale in the form of an arc corresponds to the standard design of a fuel gauge and therefore satisfies expectations with regard to the arrangement of a display of this type. This facilitates visual orientation. Adapting the LED display elements in shape and arrangement to the curved scale provides a continuous design of the display device which is easy to understand visually.

A second display element with four LED display elements may provide sufficient accuracy for estimating the ranges. Four LED display elements which are actuated according to the following conditions:
the first LED display element, arranged at the origin of the scale, is made to light up if ART≧¼
the following second LED display element is made to light up if ART≧½
the following third LED display element is made to light up if ART>¾
the following fourth LED display element is made to light up if ART=1

allow the driver to read off five different statements with regard to the additive range from the display device
all four LED display elements are lit up: the store of additive is sufficient for a full fuel tank or another full fuel tank.
three LED display elements are lit up: the store of additive is sufficient for at least three-quarters but no longer for a full fuel tank.
two LED display elements are lit up: the additive is sufficient for at least half but no longer for three-quarters of a fuel tank.
one LED display element is lit up: the additive is sufficient for at least a quarter but no longer for half a fuel tank.
no LED display elements are lit up: the additive is sufficient for at most a quarter of a fuel tank.

These five—or together with the display of the reserve range of the additive six—state indications for the range of the additive, which may be interpreted in the same manner as the display of the fuel gauge—are generally sufficient to assess the question of when to look for a refueling station. More precise division of the range display for the additive under certain circumstances may suggest an accuracy which is not present given relatively complex relationships between fuel consumption and additive consumption.

A large number of factors, including the engine speed, may form part of a range calculation, both for the fuel and for an additive which may be dependent in nonlinear fashion on the fuel consumption. The values which result from this calculation fluctuate as a function of changing conditions, such as, for example, the manner in which the vehicle is driven or the terrain, which means that neither the fuel consumption itself nor the consumption of the additive which is dependent on it decrease in linear fashion. Excessively accurate accounting for fluctuations in consumption when presenting the ranges may tend to irritate rather than help the driver. If just 5 or 6 states are indicated, fluctuating factors are smoothed out to a sufficient extent. Furthermore, the display device, if the second display element is arranged as four LED display elements, also does not become excessively complex in terms of the equipment required..

The LED display elements for indicating the range of the additive may be colored according to a color which is generally used to denote the additive. If the additive is provided with a general color designation, it increases the intuitive understanding of the display device with regard to the values indicated for the additive if the LED display elements are configured in this color, since it becomes immediately apparent that the LED display elements relate to a substance denoted by this color.

Example embodiments of the present invention are explained in greater detail below with reference to the appended Figures.

### BRIEF DESCRIPTION OF THE DRAWINGS

FIG. 1a to 1e illustrate a display device according to an example embodiment of the present invention.

FIG. 2 illustrates a display device according to an example embodiment of the present invention.

### DETAILED DESCRIPTION

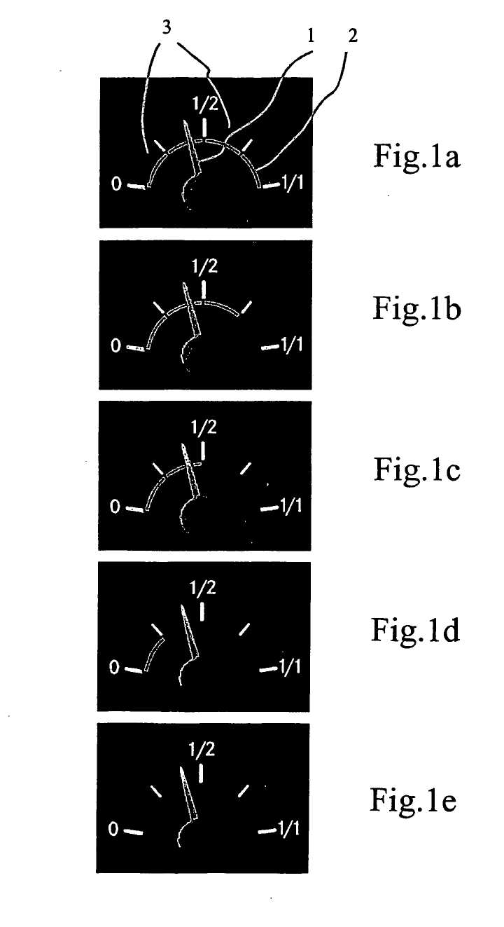

FIG. 1 illustrates a display device according to an exemplary embodiment of the present invention. FIG. 1a to 1e illustrate a fuel gauge with a semicircular scale 3 for displaying the store of fuel and with a pointer 1 for indicating the current store of fuel. The store of fuel which is displayed in this manner is usually interpreted by the driver as a range to answer the question of when the next refueling stop is due. Therefore, a scale for displaying the store of fuel is also suitable as a scale for visually estimating the range of the store of fuel. Scales indicating kilometers may also be suitable for this purpose.

Four LED display elements 2 are arranged along the scale 3 for displaying the store of fuel. FIG. 1a to 1e represent the various states for the range of the store of additive which may be distinguished with regard to the range of the store of fuel.

The configuration of the display elements illustrated in FIG. 1a—with four LED display elements 2 lit up and the pointer 1 at any point on the scale—signals to the driver in this arrangement that when he is refueling with fuel the additive is sufficient for at least another full tank, i.e., does not need to be topped up during this refueling stop.

The configurations of the display elements illustrated in FIG. 1b and FIG. 1c—with three or two LED display elements lit up and the pointer at a position within the range lit up by the LED elements—indicate that the store of additive is sufficient for the existing store of fuel and the additive should also be topped up during the next stop for refueling the fuel.

The configuration illustrated in FIG. 1d—with one LED display element lit up and the pointer at a position outside the range lit up by the LED elements—indicates that the. store of additive is no longer sufficient for the existing store of fuel, and therefore a refueling stop to top up the additive needs to be planned.

The configuration illustrated in FIG. 1e, in which none of the four LED display elements is lit up, indicates that the store of additive is only sufficient for less than a quarter of the range of a full fuel tank.

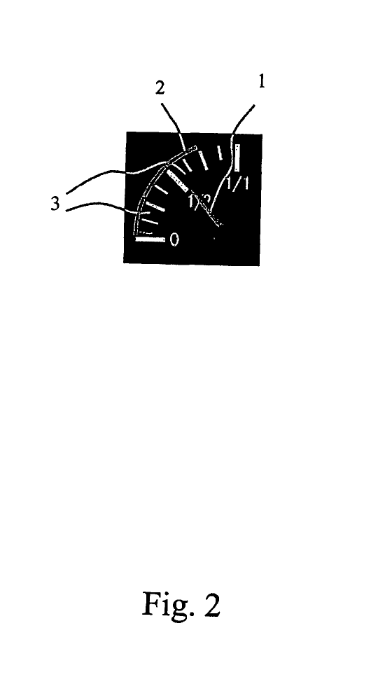

FIG. 2 illustrates a display device according to an example embodiment of the present invention, having pointer 1, display elements 2 and a scale 3 in the form of a quarter-circle.

1-13. (canceled)

14. A display device for a motor vehicle, for operation, the motor vehicle carrying a store of fuel and a store of an additive, the additive consumed by the motor vehicle as a function of fuel consumption and other driving parameters, comprising:
electronically actuable display elements adapted to indicate a range of the store of additive in accordance with a range of a full fuel tank.

15. The display device according to claim 14, further comprising an electronically actuable display element adapted to indicate a reserve range of the store of additive in accordance with a reserve range of the store of fuel.

16. The display device according to claim 14, wherein the display elements include at least one of (a) a pointer and (b) LED display elements.

17. The display device according to claim 14, wherein the display elements relate to a common scale, a first display element adapted to display the range of the store of fuel, a second display element adapted to display the range of the store of additive in accordance with the range of the full fuel tank.

18. The display device according to claim 17, wherein the first display element includes a pointer, the second display element including a plurality of LED display elements arranged along an entire scale, the LED display elements actuable to light up in succession, beginning at an origin of the scale, lit up LED display elements display the range of the store of additive in accordance with the range of the full fuel tank.

19. The display device according to claim 18, wherein the scale is arranged as an arc, the LED display elements arranged along the entire scale correspondingly curved in form.

20. The display device according to claim 17, wherein the second display includes four LED display elements.

21. The display device according to claim 17, wherein the second display includes LED display elements, a color of the LED display elements arranged according to a general color designation of the additive.

22. A method for actuating a display device for a motor vehicle, for operation, the motor vehicle carrying a store of fuel and a store of an additive, the additive consumed by the motor vehicle as a function of fuel consumption and other driving parameters, comprising:
actuating electronically actuable display elements to indicate a range of the store of additive in accordance with a range of a full fuel tank.

23. The method according to claim 22, further comprising calculating the range of the store of additive in accordance with the range of the full fuel tank as a ratio of the range of the store of additive to the range of the full fuel tank according to the following:
ART=1 if AR/KRT is greater than 1; and
ART=AR/KRT, otherwise;
wherein ART represents the ratio, AR represents the range of the store of additive, and KTR represents the range of the full fuel tank.

24. The method according to claim 23, wherein the display elements are actuated to indicate a value for the store of fuel and to indicate the value for the store of fuel and the ratio on a common scale.

25. The method according to claim 24, wherein the display elements include four LED display elements arranged along an entire scale to indicate the value of the ratio and a pointer to indicate the value for the store of fuel according to the following:
none of the LED display elements are actuated to light up if ART<¼;
a first LED display element arranged at an origin of the scale is actuated to light up if ART≧¼;
a following second LED display element is actuated to light up if ART=½;
a following third LED display element is actuated to light up if ART≧¾; and
a following fourth LED display element is actuated to light up if ART=1.

26. The method according to claim 22, wherein a display element is actuated in the actuating step if a reserve range of the store of additive is less than or equal to a reserve range of the store of fuel.

27. A motor vehicle carrying a store of fuel and a store of an additive, the additive consumed by the motor vehicle as a function of fuel consumption and other driving parameters, comprising:
a display device including electronically actuable display elements adapted to indicate a range of the store of additive in accordance with a range of a full fuel tank.
